(19) United States
(12) Patent Application Publication
(10) Pub. No.: US 2014/0278514 A1
(43) Pub. Date: Sep. 18, 2014

(54) Guided Cooperation for Medical Evaluation or Treatment

(71) Applicant: Connie Stromberg, Issaquah, WA (US)

(72) Inventor: Connie Stromberg, Issaquah, WA (US)

(21) Appl. No.: 14/217,407

(22) Filed: Mar. 17, 2014

Related U.S. Application Data
(60) Provisional application No. 61/802,000, filed on Mar. 15, 2013.

(51) Int. Cl. G06F 19/00

(52) U.S. Cl. CPC G06F 19/3481
USPC 705/2

(57) ABSTRACT

An electronic device, method, and computer-readable medium are configured to guide cooperation of a patient with a medical activity, such as evaluation and/or treatment of the patient. For example, an electronic device may comprise a processor that, in response to execution of instructions stored in a memory, causes an output to communicate one or more activities to a patient that encourage the patient to perform one or more actions that facilitate performance of a medical evaluation or treatment of the patient, such as by a medical professional. The electronic device may identify one or more actions by a patient that facilitates performance of the medical evaluation or treatment, communicate one or more activities that encourage the patient to perform the one or more actions, and while the patient is performing the one or more actions, provide time for a medical professional to perform the medical evaluation or treatment.

### CROSS-REFERENCE TO RELATED APPLICATION

This application claims the benefit of U.S. Provisional Patent Application No. 61/802,000, filed Mar. 15, 2013, the disclosure of which is hereby incorporated by reference in its entirety.

### BACKGROUND

Every day, anxious or frightened children are brought to a hospital or clinic for a medical evaluation, procedure, treatment, or surgery. Pediatric medical providers try in many ways to reduce a child's level of anxiety or fear so their medical visit is not a negative or traumatic experience. Medical providers talk to the children to build rapport and have many distraction techniques. Child Life Specialists can be called in to help a child cope with their emotions and cooperate with what needs to be done. But often the child refuses to cooperate. Gaining a child's cooperation can be difficult, and must be done at their appropriate level of development and understanding. Children can be unpredictable and this makes time management for the medical professional a challenge. Gaining cooperation is a challenge of pediatrics.

### SUMMARY

The following summary is provided to introduce a selection of concepts in a simplified form that are further described below in the Detailed Description. This summary is not intended to identify key features of the claimed subject matter, nor is it intended to be used as an aid in determining the scope of the claimed subject matter.

The present disclosure provides an electronic device, method, and computer-readable medium configured to guide cooperation of a patient with a medical activity, such as evaluation and/or treatment of the patient. In various embodiments, the present disclosure describes an electronic device that comprises a memory storing executable instructions, an output, and a processor operatively coupled to the memory and the output. In response to execution of the instructions stored in the memory, the processor is configured to cause the output to communicate one or more activities to a patient that encourage the patient to perform one or more actions that facilitate performance of a medical evaluation or treatment of the patient by a medical professional.

In various embodiments, the output may be a screen that communicates the one or more activities by displaying the one or more activities on the screen. Additionally, or alternatively, the output may be a speaker that communicates the one or more activities by audibly playing the one or more activities via the speaker.

In various embodiments, the electronic device may further comprise a motion sensor that is configured to sense movement of the electronic device. The instructions stored in the memory may cause the electronic device to respond to sensed movement while communicating the one or more activities to the patient. In at least one embodiment, the motion sensor may be a gyroscope operating in connection with the electronic device.

In various embodiments, the electronic device may further comprise a sensor configured to sense air movement. The instructions stored in the memory may cause the electronic device to respond to sensed air movement while communicating the one or more activities to the patient. In at least one embodiment, the sensor configured to sense air movement is a microphone operating in connection with the electronic device. The electronic device may further comprise an infection control device that is used to control biological interaction between the patient and the electronic device.

In various embodiments, the present disclosure also describes a method for guiding cooperation of a patient with a medical activity, such as an evaluation or treatment of the patient. In at least one embodiment, the method may comprise steps of configuring an electronic device to identify one or more actions by a patient that facilitates performance of a medical evaluation or treatment of the patient, causing the electronic device to communicate one or more activities that encourage the patient to perform the one or more actions; and while the patient is performing the one or more actions, providing time for a medical professional to perform the medical evaluation or treatment.

In various embodiments, the one or more activities communicated by the electronic device cause the patient to breathe deeply. The electronic device may include a sensor configured to sense air movement, wherein the electronic device is configured to respond to air movement from breathing by the patient during communication of the one or more activities to the patient. An infection control device may be used between the patient and the electronic device to control biological interaction of the patient with the electronic device.

In various embodiments, the one or more activities communicated by the electronic device cause the patient to hold still. The electronic device may include a motion sensor, wherein the electronic device is configured to respond to movement by the patient during communication of the one or more activities to the patient.

In various embodiments, the one or more activities communicated by the electronic device guide cooperation of the patient with an evaluation of the patient's blood pressure, with an evaluation of the patient's temperature, with an evaluation of the patient's vital statistics, with an evaluation of the patient's eyes, with an evaluation of neural and/or muscular activity of the patient, with a prescribed therapy by the patient outside of the presence of a medical professional, and/or with induction of sedation prior to a medical activity.

Also disclosed herein is a non-transitory, computer-readable medium on which computer-executable instructions are stored. In response to execution by an electronic device, the instructions cause the electronic device to identify one or more actions by a patient that facilitates performance of a medical evaluation or treatment of the patient by a medical professional, communicate one or more activities to the patient that encourage the patient to perform the one or more actions, and while the patient is performing the one or more actions, provide time for the medical professional to perform the medical evaluation or treatment. The one or more activities communicated by the electronic device may guide cooperation of the patient with any of the above-described medical activities.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 illustrates a variety of guided cooperation programs that help a medical professional perform medical activities on a patient by inducing deep breathing by the patient;

FIGS. 2A-2C illustrate one example of an activity sequence that promotes guided cooperation by a patient while a medical professional obtains vital information from the patient;

FIG. 3 illustrates another guided cooperation program that helps a patient cooperate with a medical professional attempting to evaluate the patient's blood pressure;

FIGS. 4A and 4B illustrate another example of a guided cooperation program assisting a patient with a visit to a medical professional's office;

FIGS. 5A and 5B illustrate a variety of guided cooperation programs that encourage a patient to hold still and/or be quiet during medical activities;

FIG. 6 illustrates one example of a guided cooperation program that helps a patient with dysfunctional voiding/withholding syndrome comply with prescribed therapy at home;

FIG. 7 illustrates a program of guided physical therapy exercises that may be performed at home; and

FIGS. 8A and 8B illustrate a guided cooperation program that helps prepare a patient for a planned day surgery.

### DETAILED DESCRIPTION

Disclosed herein are methods and systems that pair the advent of newer technology in portable electronic devices and a professionally designed program or application (app) for “Guided Cooperation” that uses the affinity that children have with electronic devices. This program (app), which is executable on an electronic device, is designed to elicit responses in children that facilitate a medical activity. These methods and systems offer a new way to gain cooperation.

Children who have been previously exposed to electronic media readily embrace the presented activity, but even children not accustomed to technology can benefit. When a child is given a device for the purpose of distracting them from their surroundings or medical activity, they usually quickly and readily “engage” with the electronic activity and are successfully distracted. Sometimes, when under stress, children (especially autistic children) prefer devices to human (especially stranger) interaction. It can be used as a coping mechanism for children.

Using devices for pure distraction is becoming common in medical settings. Although games, animated cartoons, movies, etc., are used now by parents and professionals and are available ad hoc, they are not packaged together in sequences designed by medical professionals nor are they configured to elicit specific activities that facilitate a medical evaluation or treatment. While some electronic activities are presently available, they are now typically novelties for entertainment; they are not used to elicit responses by children that are useful for medical purposes.

In various embodiments, a “Guided Cooperation” program (app) as described herein presents an activity or sequence of activities on the screen of an electronic device, typically a mobile electronic device such as a smartphone, a tablet computer, a portable media player, etc. The activity or sequence of activities are designed and implemented to elicit responses by a patient that is specifically desired by a medical professional who is evaluating or treating the patient. The patient's participation in the activity or sequence of activities helps facilitate or accomplish the medical professional's plan of care for the patient. The child may or may not be aware that they are cooperating. From their point of view, they are just “playing the game.” No coaxing or lengthy explanations are required.

By using the methods and systems described herein, medical evaluations and treatments may be completed in a more timely fashion, with less stress and negative memories and associations for the child, with more satisfaction for the parent, with better outcomes for the professional, and possibly less anxiolytic medication used.

In various embodiments, a “Guided Cooperation” program (app) may be customized to be used by (but not limited to) anesthesiologists, physicians (e.g., pediatricians), nurses, child life specialists, respiratory therapists, radiologists, physical therapists, and dentists.

Although the disclosure and the examples described herein are focused on children, the concepts, processes, and benefits are applicable to people of all ages. Furthermore, the examples provided here are only representative of the types of guided cooperation that can be achieved with the methods and systems of the present disclosure.

In various embodiments, an electronic device is provided to guide the cooperation of a patient in a medical evaluation or treatment. The device generally includes a screen and a processor configured to execute program instructions that cause the screen to display animations, videos, game elements, etc., that are of interest to the patient. The device may also include audio inputs and outputs to engage the patient.

The device is configured to present an activity for the patient to do. In some embodiments, the activity is not immediately indicative of a medical evaluation or treatment that an attending medical professional is attempting to perform on the patient. Nevertheless, given the interest and desire of the patient to engage in the activity, the patient is encouraged to undertake actions that enable the medical professional to accomplish the medical evaluation or treatment. While the activity is not particularly related to the medical evaluation or treatment, the activity causes the patient to do what the medical professional needs the patient to do to achieve a desired medical result. In various embodiments, the term “medical evaluation or treatment” includes, but is not limited to, examination, evaluation, diagnosis, therapy, treatment, and other procedures that result in a physiological, mental, or emotional outcome.

Generally, an electronic device configured to implement a “guided cooperation” program according to the present disclosure may be provided by a medical professional to a patient during an evaluation or treatment. The device presents an activity for the patient to watch or listen, and to react by taking actions that, potentially unknowing to the patient, are helpful to accomplish the intended medical evaluation or treatment. While the patient is engaged in the activity being presented on the device, the medical professional performs the desired evaluation or treatment.

In various embodiments, activities that are not immediately indicative of the medical evaluation or treatment are activities that do not directly convey or tell the patient what to do but nonetheless cause or invoke action on the part of the patient, resulting in the patient doing what the medical professional needs for the patient to do in order for the medical evaluation or treatment to be successful. In other embodiments, the activities presented on the device may tell the patient more directly what he or she should do, but the actions are not particularly tied to the medical evaluation or treatment at hand. Rather, the patient engages in the activity because they wish to see a positive outcome of the activity on the device.

The following description provides a variety of examples that illustrate embodiments of applications, activities, patient (e.g., child) actions, and medical activities that demonstrate the method steps and results of programs configured in accordance with the present disclosure.

As a first example, FIG. 1 illustrates a variety of guided cooperation programs (or “apps”) that may be executed on an electronic device to induce deep breathing by the patient to assist a medical professional to provide evaluation or treatment in which deep breathing by the patient is needed. As indicated, the programs may present one or more blowing games or activities that encourage the patient to breathe deeply.

For instance, a “birthday candles” activity may depict animated candles on a screen of the electronic device and encourage the patient to “blow out” the candles. The electronic device may be configured with a sensor, such as a microphone, that can sense exhaled air from the patient and cause an effect on the screen. The patient may blow onto the microphone or other sensor and observe the effects on the screen. In this example, the patient's blowing causes the flames on the candles to sway and possibly extinguish. While it is not immediately apparent to the patient that the activity is encouraging deep breathing (i.e., inhalation and exhalation by the patient), the net result is direct breathing by the patient that assists the medical professional providing an evaluation or treatment of the patient. As may be appropriate, an infection control device such as a filter or covering may be used between the patient's mouth and the device microphone or other sensor to control biological interaction of the patient with the electronic device.

Other blowing games or activities provided by the guided cooperation program may include one or more of: an illustration of animated pinwheels in which the pinwheels spin in response to blowing by the patient; an illustration of bubbles in which blowing by the patient produces images of bubbles to appear and/or move on the screen; an illustration of one or more colorful balloons in which blowing by the patient causes the balloons to inflate; an illustration of musical wind instruments in which blowing by the patient causes musical notes to be played by the instruments; an illustration of wind blowing games or toys, such as an animated woodcutter, hammering man, weathervane, and/or wind chimes that react to patient breathing by causing sounds from movement of the animated features; an illustration in which the patient can feed animals by blowing an animated treat into the mouths of depicted animals (fish, dog, cat, frog, etc.); and an illustration of an animated ball in which blowing by the patient causes movement of the ball to move toward a goal.

As the patient engages in the foregoing blowing activities, the resultant deep breathing by the patient is useful to a medical professional that may be engaged in a variety of medical activities. For instance, the medical professional may be engaged in auscultation or evaluation of the patient's lungs in which the medical professional uses a stethoscope on the patient's chest to listen to the patient's lung sounds. In another case, the medical professional may be administering anesthetic gas and the patient's breathing assists with inhalation of the anesthetic gas for sedation during induction of general anesthesia and/or other medical gas. In another case, the patient's breathing may assist the medical professional by causing the patient to inhale introduced medication, for example, bronchodilators or other therapeutic medication possibly to enhance lung function. In yet another case, the medical activity assisted by the patient's breathing may include use of an incentive spirometer for atelectasis, e.g., for patient lung alveoli re-inflation whenever medically indicated (after surgery or after periods of bed rest, etc.).

FIGS. 2A-2C illustrate one example of an activity sequence that promotes guided cooperation by a patient while a medical professional is engaged in obtaining vital statistical information from the patient. Beginning with FIG. 2A, in this example the program starts with an animated cartoon of a familiar story in which an audible voice tells a story involving three little pigs. The animated cartoon may be narrated according to a choice of languages. This activity engages the patient in the story and distracts the patient from their medical surroundings.

As indicated, the story may include a pig working very hard to build a house and the patient being told that the pig is getting very hot. The program asks for the patient's assistance in taking the pig's temperature. An animated thermometer is shown taking the pig's temperature using one of a variety of methods, including oral, axillary, temporal, or tympanic methods. The method, which may be preselected by the medical professional, depicts the animated pig having his temperature taken. The patient watches a model of how it is done, with a smiling pig showing that it doesn't hurt. The animation depicts a correlation between the hot pig and the pig's temperature reading. As part of the activity, the program may encourage the patient to hold the pig still until a beep is heard. After the device makes an audible beep, the pig may engage in a dance and the patient is congratulated for their help.

At this stage, the program may indicate to the patient to hold still while the patient's temperature is likewise taken. The patient may be asked to hold still until a beep is heard. During this time, the electronic device may be programmed to sense movement by the patient and provide affirming feedback to the patient when he or she is holding still. While the patient holds still, the patient allows his or her temperature to be taken by the medical professional, preferably using the same method and form of thermometer (oral, axillary, temporal, or tympanic) that was used with the animated pig. In coordination with a beeping sound signaling a successful reading of the patient's temperature, the program may end with a similar dance by the pig with congratulations to the patient for holding still. As a result, the patient feels rewarded for their effort and the medical professional has successfully completed the intended medical evaluation.

Turning now to FIG. 2B, the guided cooperation program may continue with the three pigs story and depict a wolf arriving on the scene. The story may show a pig running into a house, hiding, and holding still while the wolf listens. A stethoscope may be shown along with large animated heartbeats. The patient listens to the pig's heartbeats and then is encouraged to hold still while the medical professional listens to the patient's heartbeat. Again, the device may be programmed to sense movement by the patient and affirm the patient's efforts to hold still while the medical professional uses a stethoscope to auscultate the patient's cardiac rate and rhythm.

Once the heart auscultation is completed, the program may continue with the story that induces further action by the patient to assist the medical professional auscultate patient's lungs. In this activity, the story may indicate that the wolf is going to blow the house down, along with an animated action of the wolf's blowing action and consequent results. The patient sees a model of the activity (the wolf blowing the house away) that the patient can mimic. The program encourages the patient to likewise blow on the house and senses air movement from the patient, e.g., using a microphone or other sensor on the device. As a patient blows into the microphone, the patient sees the effect of the house being blown way and scattering into the wind. A feedback loop in the program may cause the patient to repeatedly blow air, thus inducing deep breathing by the patient that assists the medical professional evaluating the patient's lung sounds and breathing rate.

In this example, the sequence of activities presented by the program may next show the pig running to his brother's house and giving him a tight hug. Both pigs hold very still while they listen for the wolf. While a blood pressure cuff is applied to the patient, the program may ask the patient to hold very still while the cuff provides a tight “hug.” The patient may be told that the cuff will give a tight hug and then let go. The patient is assured that the hug doesn't hurt. As with previous sequences, the program may utilize sensors, such as a gyroscope operating in the electronic device, to detect motion and provide feedback to the patient encouraging the patient to hold still. As the child is engaged in the story and holds still, the medical professional is able to pressurize the cuff and appropriately evaluate the patient's blood pressure. At the same time, the patient is emotionally supported and coached through actions that are helpful to the medical professional.

Turning now to FIG. 2C, the program proceeds towards a conclusion in which the illustrated pigs run to their brother's house made of bricks and wait to hear if the wolf is coming. The wolf is shown arriving at the house but no matter how hard he blows, he cannot blow down the strong brick house. As the wolf runs away and the pigs are shown dancing, the pigs are congratulated. The patient similarly feels approval for his or her participation in the successful outcome of the story.

FIG. 3 illustrates another guided cooperation program that may be used by a medical professional attempting to evaluate a patient's blood pressure. The program may depict a little boy on the screen of the electronic device. The boy is described as being very strong and is shown performing various feats of strength. The program may then engage the patient in measuring the strength of the little boy's muscles. A “muscle tester” is placed on the little boy's arm as the little boy holds still. The muscle tester is described as simply giving the boy's arm a little squeeze and then “it is all done.” In the animation, a blood pressure cuff is placed on the cartoon boy's bicep, after which the “strength meter” shows exciting results. The program may further depict friends of the little boy and indicate that many of his friends likewise wish be tested.

As the program describes how a blood pressure cuff will be applied to the patient's arm, the patient is encouraged to hold still while the cuff gives a little squeeze and releases. The patient is encouraged to continue holding still while the medical professional applies the blood pressure cuff to the patient's arm. Feedback from motion sensors within the device can be used to affirm the patient's efforts to hold still. The patient holds still and, in at least one embodiment, watches a cartoon meter on the screen depicting similar “strength” by the patient. As a result, the cooperative behavior by the patient is positively reinforced while the medical professional completes the blood pressure evaluation.

In FIG. 4A, another example of a guided cooperation program is shown assisting a patient with a visit to a medical professional's office, such as a pediatrician's office. An audible voice may prompt the patient with a query “How big are you?” and show one or more children (real life and/or animated) standing on a scale to see how much they weigh. The depicted children may demonstrate how to stand in the middle of the scale and hold still, and then ask the patient to try it. While patient stands on the scale and holds still (as measured by motion sensors on the device and reaffirmed to the patient), the medical professional is able to obtain a weight measurement of the patient.

The program may next prompt the patient with a query “How tall are you?” and show one or more children (real-life and/or animated) standing next to a wall and backing up until their backs and their heels touch the wall. The program notes that the children stand straight and tall, looking straight ahead, while holding still. The patient then is prompted to similarly try it. While holding the electronic device, the patient stands against a wall in proper form and holds still, as may be measured by one or more motion sensors within the device. The medical professional is thus able to obtain a height measurement of the patient.

Next, to assist the patient through a physical examination, the program may engage the patient in various activities such as a freeze tag, statue, or hold still game. Utilizing a gyroscope within the device to detect motion, the patient is prompted to hold still and be quiet, thereby permitting the medical professional to auscultate the patient's heart. The program may engage the patient in blowing games, such as previously described in FIG. 1. Utilizing air detection capabilities of the device, such as a microphone, to encourage deep breathing by the patient, the gameplay of the program causes the patient to inhale and exhale deeply while the medical professional auscultates the patient's lungs.

In another activity, the program may invite the patient to look at a depiction of eyes on the screen of the electronic device. The program may utilize a gyroscope or other sensory function of the device to sense movement of the device and produce a depiction on the screen in which the eyes maintain their “gaze” upon the patient. In response, the patient's eyes are encouraged to follow the eyes on the device as the device moves. The medical professional may move the device left and right, up and down, and diagonally, and cause the patient's eyes to move accordingly. During this time, the medical professional is able to evaluate the patient's eye movement, such as to assess the cranial nerves associated with eye coordination of the patient.

As indicated in FIG. 4B, the program may further depict a walking, skipping, or hopping demonstration game in which real-life or animated children are shown walking, skipping, or hopping, to demonstrate desired behavior. The patient initially watches the demonstration, after which the program encourages the patient to mimic the depicted behavior. The patient thus walks, skips, or hops to their best ability while the medical professional assesses the patient's motor skills, gait, and/or muscle coordination.

The program may also engage the patient in action songs that direct specific movement. For example, a familiar song referring to the patient's head, shoulders, knees, and toes may be played while the program depicts a demonstration of kids bending and stretching to the song. The patient initially watches the demonstration, after which the program encourages the patient to mimic the depicted behavior. In this instance, the patient bends and stretches in accordance with the song, during which time the medical professional may evaluate the flexibility and/or range of motion of the patient that may be useful in screening scoliosis, for example.

FIGS. 5A and 5B illustrate a variety of guided cooperation programs that encourage patients to hold still and/or be quiet while a medical professional engages in a variety of medical activities with the patient. For example, in a “freeze-frame” game, the program may utilize a mirror and/or camera function of the device to take and hold a picture of the patient and encourage the patient to hold the “frozen” stance for a predetermined period of time. The program encourages the patient to look into the mirror/camera while a picture is taken. The patient must then keep still to maintain the picture in the frame until a timer expires.

As another example, in a “statue” game, the program may utilize a mirror and/or camera function of the device to take a picture of the patient, and if the patient remains still, the program animates the picture into a cartoon statue. If the device detects movement of the patient, the cartoon statue may develop cracks and/or crumble if sufficient motion is detected. As a result, the patient is encouraged to hold still after the picture is taken to observe the reward of seeing a transformation of their self-portrait into the cartoon statue or character without the statue crumbling. The time period required for the process to complete is sufficient to allow the medical professional to perform an intended medical evaluation or treatment of the patient.

As yet another example, in a “deep freeze” game, the program may again utilize a minor and/or camera function of the device to take a picture of the patient, and if the patient remains still, the program animates the picture with growing icicles and turning into ice. If the device detects movement of the patient, e.g., using a gyroscope or other motion detection sensor of the device, the ice may develop cracks and/or crumble or “thaw” if sufficient motion is detected. As a result, the patient is encouraged to hold still after the picture is taken to observe the reward of seeing their self-portrait transformed into frozen ice.

As still another example, in a “staring contest” the program may depict a close view of a face on the screen, such as the face of an animal. The eyes of the depicted face rarely blinks while the device keeps track of time. The program may be configured to score the patient on the patient's effort to stare at the depicted face without blinking, perhaps using an “honor system” input from the patient to indicate when a blink has occurred. As a result, the patient stares into the eyes of the animal to see how long they can go without blinking in competition with the depicted animal. The patient may provide input to a scorecard to identify the winner of each round of competition.

Additional examples of activities that encourage a patient to hold still and/or be quiet are further shown in FIG. 5B. In a “1-2-3 hush puppies” game, the program may depict puppies on the screen being quiet. After the patient and/or the medical professional says “1-2-3 hush puppies,” the game becomes a quiet contest between the patient and the animated puppies. After a predetermined amount of time, the puppies begin to do funny things that may cause the patient to laugh or make a noise. As a result, for a period of time, the patient remains quiet and is occupied by the game. During this time, the medical professional is able to perform an intended medical evaluation or treatment of the patient.

As a final example, the program may be configured to play a game in which the patient attempts to keep a ball on a table. The electronic device may act like a tilt table that utilizes an internal gyroscope or other motion sensor to detect movement of the device. The goal of the game is to keep the ball in a target area until a timer expires. As a result, the patient concentrates on the game to keep the device still until the timer goes off. For example, the program may attempt to keep the child engaged for 15-60 seconds during which the medical professional performs an appropriate medical procedure on the patient.

With each of the above “holding still” or “quiet” games, the medical professional may use the time in which the child is engaged in the game to perform a variety of medical activities, such as listening to the patient's heart and lung sounds or abdominal bowel sounds with a stethoscope. The medical professional may similarly be able to examine the patient's ears, eyes, mouth, nose, or lymph nodes. In other cases, for example, the medical professional may be able to perform an abdominal palpation to evaluate the health of internal organs, such as the liver, spleen, etc.

While the foregoing principle embodiments of the program (app) are useful while in the presence of a medical professional, a “home version” of the program may be configured to help encourage the patient to continue a prescribed plan of care or home therapy when the medical professional is not present. The program may thus be a tool that promotes better compliance by the patient.

As one example depicted in FIG. 6, a urologist assisting a patient with a dysfunctional voiding/withholding syndrome may prescribe therapy in the form of timed voiding sessions that occur at home during the day. The program thus overcomes challenges faced by medical professionals and parents in getting patients, in this case typically toddlers, to remain on a toilet for a prescribed session.

For instance, the electronic device may be mounted near a toilet so the patient can be hands-free while observing the program. The program may include alarms that activate at predetermined intervals during the day, for example, every two hours. When the patient hears the alarm, the patient understands they must stop their current activity and move to the bathroom to silence the alarm. The patient is then cued to sit on the toilet. Voice recognition in the device may respond after the patient sits on a toilet and says that they are ready.

In one or more subsequent sequences, the program may provide guided relaxation exercises with appropriate relaxation imagery and voice direction to guide the patient to relax various muscle groups and/or listen to relaxing sounds, possibly water sounds. The patient responds by relaxing their body, specifically pelvic floor muscles, which can facilitate relaxation and emptying of the bladder.

In another subsequent or alternative sequence, the program may detect a short segment or chapter of a continuing story that is read to the patient. Voice narration and/or visual effects are shown on the screen and while the patient engages with the story, the patient remains on the toilet until the activity is done. The time interval allows signals from the bladder to go to the patient's brain that cause the patient to successfully coordinate neuromuscular activity resulting in complete emptying of the bladder. The timing of the segment may be programmed in accordance with the patient's age. Alternatively or in addition, short cartoon segments may be available for the patient to watch while the patient's body is given time to successfully void the bladder. As may be appropriate, the program may be further configured to reward the patient with congratulations so that the patient makes positive associations with the activity. The result is that the program promotes better bowel and bladder health and habits of the patient.

If desired, the program may be further configured to lock out the story for a period of time, such as two hours, until the next alarm occurs. By keeping the patient interested in the story or other activities, the odds of the patient returning for further programming is increased. Such repetition by the patient medically reinforces neuromuscular pathways until nerve myelinization and maturation occurs.

FIG. 7 illustrates a program of guided physical therapy exercises that may be performed at home. A medical professional, such as a physical therapist, may prescribe certain exercises during sessions with the patient in clinic. Follow-up exercises to be performed at home are presented at home by the electronic device. Such physical therapy exercise sequences may be demonstrated, timed, and/or counted, and the electronic device can be programmed to change the exercises or routines for different days.

For example, real-life or cartoon children may demonstrate a dance routine or other exercise movement while a timer starts. The patient watches and engages in the demonstrated activity. In one case, the program may prompt the patient to march in place and wave their arms as shown on the screen. In the activity as shown, the depicted children may perform as a marching band and play music with hand motions that the patient can mimic. As a result, the patient marches in place and makes similar hand motions that cause the patient to stretch their large muscles.

In another case, the program may prompt the patient to perform a standing stretch while holding onto a chair or wall. The depicted children may perform a similar stretch on the screen and ask the patient to hold the stretch until they hear a beeping sound. The patient performs the depicted stretching and after a period of time, such as 30 seconds, a timer expires causing a sound to play. As a result of this activity, for example, the program may cause the patient to stretch the quadriceps of both legs in multiple sets of exercise over multiple time periods.

In yet another case, the program may prompt the patient to perform a bridge stability activity. Real-life and/or cartoon children may demonstrate a posture acting as a bridge and encourage the patient to mimic their activity. A number counter on the screen may be used to keep track of the number of repetitions the patient has performed until a goal is reached. Each time the patient performs the directed activity, the patient may touch the counter to count the repetitions. The patient's engagement in the activity is thus recognized and positively reinforced. While engaging in such bridge stability activities, for example, the patient may improve trunk stability of their body in multiple sets performed over multiple time periods.

Turning now to FIG. 8A, a guided cooperation program as described herein may help prepare a patient for a planned day surgery. As part of preparing for the day surgery, the program may help the patient be ready for a mask induction. In one example as illustrated, a little girl may be shown waking up early to go to the hospital. The girl is shown not eating or drinking anything for breakfast, e.g., while a cartoon “tummy cam” zooms in to show an empty stomach. The patient is asked if they likewise did not eat or drink anything for breakfast and are congratulated for doing so.

The program may continue by depicting the girl changing into hospital pajamas and meeting with the medical professionals who will be taking care of her. The medical professionals are shown to be very nice and gently talking to her. When the patient experiences similar activity at the clinic or hospital, the patient will understand what is happening.

The program may show the girl choosing her favorite song. She is shown singing the song right before she is sedated for her operation. The program helps the patient understand that they will go to sleep during their operation and simply wake up when it is all done. In various embodiments, the program may query the patient for their favorite song and encourage the patient to similarly sing the song later in the day as they are being sedated. Samples of songs may be played by the electronic device to help the patient select a favorite song. If appropriate, later in the day prior to induction, the device may play the patient's selected song and encourage the patient to sing the song.

As illustrated in FIG. 8B, the program may next show the girl lying down on a bed in preparation for the operation. As the girl sings her song (or engages in other activities such as watching a movie or play in a game), the girl holds still while a mask covers her mouth and nose and she takes a few deep breaths to sing her song. The program may further depict favorable smells that the girl can smell. The patient may likewise be prompted to choose a smell that they wish to smell later in the day as they are being sedated. As the program depicts the girl peacefully sleeping, the patient becomes familiar with the application of a mask and what to expect during induction. After engaging in this sequence of activity, the patient has a better understanding of the tasks to be performed and should cooperate better with the anesthesiologist's instructions.

To further assist the patient's understanding, the program may depict the girl waking up to smiling nurses and being wheeled out to greet family members. The girl may then be shown drinking some juice or consuming other refreshments, after which she gets dressed in her own clothes and goes home. The patient sees how the event unfolds, which reduces their anxiety of the unknown. As the patient's anxiety is reduced, less anxiolytic medication may be needed. Just as the girl is congratulated for her behavior in the program, the patient may likewise be congratulated as they successfully perform the same activities.

While the foregoing description illustrates various embodiments of guided cooperation programs, it will be appreciated that changes can be made therein without departing from the spirit and scope of the present disclosure.

The embodiments of the invention in which an exclusive property or privilege is claimed are defined as follows:

1. An electronic device configured to guide cooperation of a patient with a medical activity, the electronic device comprising:
a memory storing executable instructions;
an output; and
a processor operatively coupled to the memory and the output, wherein in response to execution of the instructions stored in the memory, the processor is configured to cause the output to communicate one or more activities to a patient that encourage the patient to perform one or more actions that facilitate performance of a medical evaluation or treatment of the patient by a medical professional.

2. The electronic device of claim 1, wherein the output is a screen, and wherein the output communicates the one or more activities by displaying the one or more activities on the screen.

3. The electronic device of claim 1, wherein the output is a speaker, and wherein the output communicates the one or more activities by audibly playing the one or more activities via the speaker.

4. The electronic device of claim 1, further comprising a motion sensor configured to sense movement of the electronic device, wherein the instructions cause the electronic device to respond to sensed movement while communicating the one or more activities to the patient.

5. The electronic device of claim 4, wherein the motion sensor is a gyroscope operating in connection with the electronic device.

6. The electronic device of claim 1, further comprising a sensor configured to sense air movement, wherein the executing instructions cause the electronic device to respond to sensed air movement while communicating the one or more activities to the patient.

7. The electronic device of claim 6, wherein the sensor configured to sense air movement is a microphone operating in connection with the electronic device.

8. The electronic device of claim 1, further comprising an infection control device that is used to control biological interaction between the patient and the electronic device.

9. A method for guiding cooperation of a patient with a medical activity, the method comprising:
configuring an electronic device to identify one or more actions by a patient that facilitates performance of a medical evaluation or treatment of the patient;
causing the electronic device to communicate one or more activities that encourage the patient to perform the one or more actions; and
while the patient is performing the one or more actions, providing time for a medical professional to perform the medical evaluation or treatment.

10. The method of claim 9, wherein the one or more activities communicated by the electronic device cause the patient to breathe deeply.

11. The method of claim 10, wherein the electronic device includes a sensor configured to sense air movement, and wherein the electronic device is configured to respond to air movement from breathing by the patient during said communication of the one or more activities to the patient.

12. The method of claim 11, further comprising providing an infection control device that is used between the patient and the electronic device to control biological interaction of the patient with the electronic device.

13. The method of claim 9, wherein the one or more activities communicated by the electronic device cause the patient to hold still.

14. The method of claim 13, wherein the electronic device includes a motion sensor, and wherein the electronic device is configured to respond to movement by the patient during said communication of the one or more activities to the patient.

15. The method of claim 9, wherein the one or more activities communicated by the electronic device guide cooperation of the patient with an evaluation of the patient's blood pressure.

16. The method of claim 9, wherein the one or more activities communicated by the electronic device guide cooperation of the patient with an evaluation of the patient's temperature.

17. The method of claim 9, wherein the one or more activities communicated by the electronic device guide cooperation of the patient with an evaluation of the patient's vital statistics.

18. The method of claim 9, wherein the one or more activities communicated by the electronic device guide cooperation of the patient with an evaluation of the patient's eyes.

19. The method of claim 9, wherein the one or more activities communicated by the electronic device guide cooperation of the patient with an evaluation of neural and/or muscular activity of the patient.

20. The method of claim 9, wherein the one or more activities communicated by the electronic device guide cooperation of the patient with a prescribed therapy by the patient outside of the presence of a medical professional.

21. The method of claim 9, wherein the one or more activities communicated by the electronic device guide cooperation of the patient with induction of sedation prior to a medical activity.

22. A non-transitory, computer-readable medium containing computer-executable instructions stored thereon, wherein the instructions, in response to execution by an electronic device, cause the electronic device to:
identify one or more actions by a patient that facilitates performance of a medical evaluation or treatment of the patient by a medical professional;
communicate one or more activities to the patient that encourage the patient to perform the one or more actions; and
while the patient is performing the one or more actions, provide time for the medical professional to perform the medical evaluation or treatment.
